(19) United States
(12) Patent Application Publication
(10) Pub. No.: US 2007/0050789 A1
(43) Pub. Date: Mar. 1, 2007

(54) Device for reducing the backlash of optical pickup head of optical disk device

(76) Inventors: Chun-Yao Wang, Hsincu City (TW); Chia-Hao Ou, TaiChung Hsien (TW)

Correspondence Address: LIN & ASSOCIATES INTELLECTUAL PROPERTY, P.O. BOX 2339, SARATOGA, CA, 95070-0339, US

(21) Appl. No.: 11/339,385

(22) Filed: Jan. 25, 2006

(30) Foreign Application Priority Data
Aug. 30, 2005 (TW) 094214954

(51) Int. Cl. G11B 17/04

(52) U.S. Cl. 720/607

(57) ABSTRACT

A device for reducing backlash of the transmission set of the optical pickup head of an optical disk device is provided. The device includes a guide rod penetrating an optical pickup head and a rack. The rack is engaged to a gear. The gear is driven by a motor so that the optical pickup head and the rack moves straight along the guide rod. The optical pickup head includes an elastic element. The elastic element apply a force to the rack so that the rack rotates around the guide rod and moves closer to the root of the gear to reduce the backlash between the gear and the rack and improve the partial deformation of the end of the rack due to the weak structure.

### FIELD OF THE INVENTION

The present invention generally relates to a device applicable to an optical disk device, and more specifically to a device for driving an optical pickup head of optical disk device to move for backlash reduction.

### BACKGROUND OF THE INVENTION

The conventional optical disk device includes an optical system, a hardware PCB and a precise mechanism. The structure of an optical disk device can be divided into a Mecha and a Loader. The Loader is for carrying the disc in and out of the optical disk device. The optical pickup head of the Mecha is for reading data from the disc or writing data into the disc. The optical pickup head is driven and precisely aligned by a transmission mechanism. The conventional mechanism for driving an optical pickup head is to use a guide rod penetrating an optical pickup head and rack. The rack is engaged to a gear, and the gear is driven by a motor so that the optical pickup head and the rack will move straight along the guide rod.

The aforementioned rack is attached to the optical pickup head; therefore, the rack is fixed at a specific angle. The drawback of this structure is that the gear is easily stuck with the rack when the optical pickup head reaches the extremes of its movement and the rack cannot transmit the force because of the stopper.

An improvement is to keep the rack from attached to the optical pickup head. In stead, a elastic element is installed at the optical pickup head. The elastic element forces are parallel with center distance which is between gear and rack. Although this structure allows the rack to absorb some transmission force when the rack hitting the stopper, the direction of force results in the force is unevenly on the rack, which may cause to increase the friction is between the gear and the rack.

### SUMMARY OF THE INVENTION

The present invention has been made to overcome the above-mentioned respective drawbacks of conventional optical pickup head having a rack attached or using an elastic element to apply the force. The primary object of the present invention is to provide a device for provide an elastic force at the appropriate position of the rack while keeping the direction perpendicular to the center distance between the rack and the gear. With this design, the rack will rotate due to the elastic force to reduce the backlash of the gear and the rack; therefore, the increase of friction caused by the mismatch between the gear and the rack can be avoided.

In addition, the present invention may further include a circular rib on the gear to prevent the rack from over-rotation resulting in the interference between the tip of the teeth of the gear or the rack and the bottom of the gear or the rack.

The present invention further uses an elastic element to apply to the location between the strong and the weak location of the structure. The force at this location will help to enhance the tail structure of the rack; therefore, the rack can avoid becoming stuck with the gear when the rack is partially deformed due to the weak structure, which is resulted from the sudden stop of the optical pickup head at the tail of the rack after the optical pickup head is moved fast to the end of the rack.

Based on the structure, the present invention provides a device for reducing backlash of the transmission set of the optical pickup head of optical disk device. The device includes a guide rod penetrating the optical pickup head and rack. The rack is engaged to a gear. The gear is driven by a motor so that the optical pickup head and the rack moves straight along the guide rod. The optical pickup head includes an elastic element. The elastic element apply a force to the rack so that the rack rotates around the guide rod and moves closer to the root of the gear to reduce the backlash between the gear and the rack and improve the partial deformation of the end of the rack due to the weak structure.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic 3D view of the present invention;

FIG. 2 shows a schematic side view of the present invention;

FIG. 3 shows a schematic front view of the present invention;

FIG. 4 shows a schematic 3D view of the elastic element of the present invention; and

FIG. 5 shows a schematic view of weak points of the rack of the present invention.

### DETAILED DESCRIPTION OF THE PREFERRED EMBODIMENTS

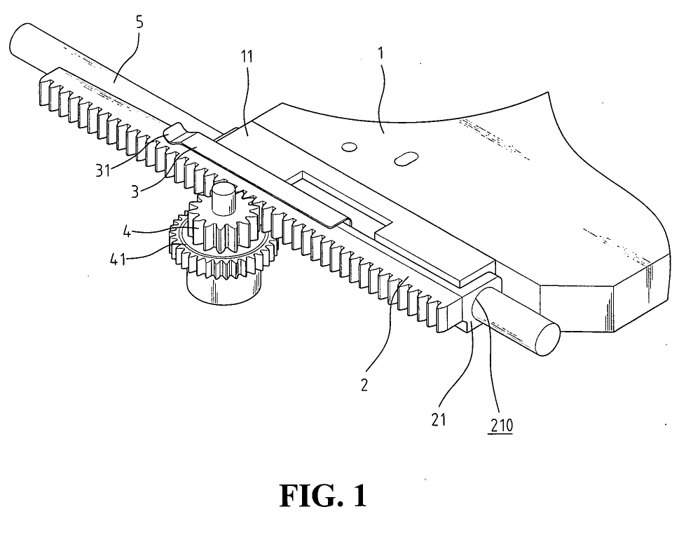

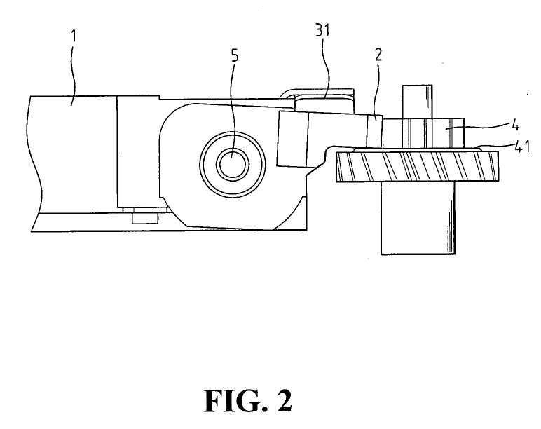

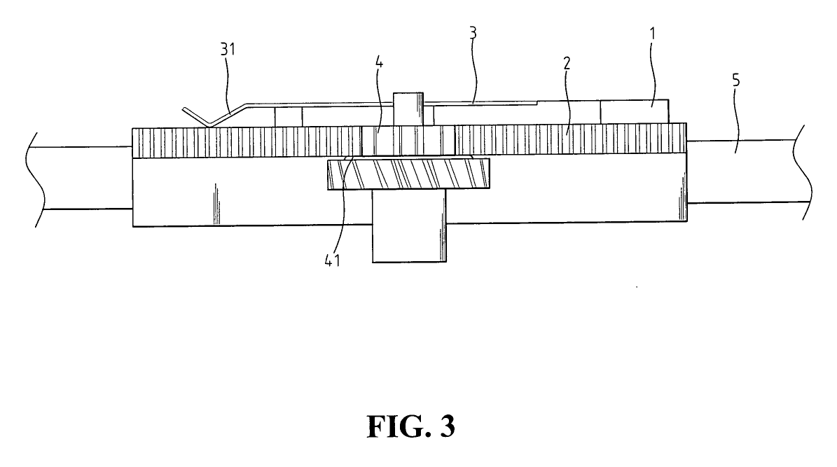

Refer to FIG. 1, FIG. 2 and FIG. 3. The device for reducing backlash of the transmission of the optical pickup head of the present invention includes an optical pickup head 1, a rack 2, an elastic element 3, a gear 4 and a guide rod 5. Optical pickup head 1 is an optical device that can read data on the optical disk or write data to the optical disk.

Both ends of rack 2 include a side plate 21. Each side plate 21 includes a via hole 210 with diameter slightly larger than that of guide rod 5. The side of optical pickup head 1 is installed with an extension plate 11. Extension plate 11 includes a via hole penetrating the horizontal position (not shown), with diameter slightly larger than the outer diameter of guide rod 5. It is preferable that the distance between side plates 21 of rack 2 is equal to the length of extension plate 11 of optical pickup head 1. After extension 11 is placed between two side plates 21, and guide rod 5 penetrates the via of extension 11 and via hole 210 of two side plates 21, optical pickup head 1 and rack 2 will move together along guide rod 5. Rack 2 is engaged to a gear 4 for driving. In other words, guide rod 5 is perpendicular to the center distance of rack 2 and gear 4.

Gear 4 of FIGS. 1-3 includes two concentric gears, one large and the other small. The small gear is on the top and engaged to rack 4. The large gear is engaged to the gear link (not shown), which is connected to the driving gear of the motor. The large gear includes a circular rib 41 so that the bottom of rack 2 corresponds to the top of rib 41.

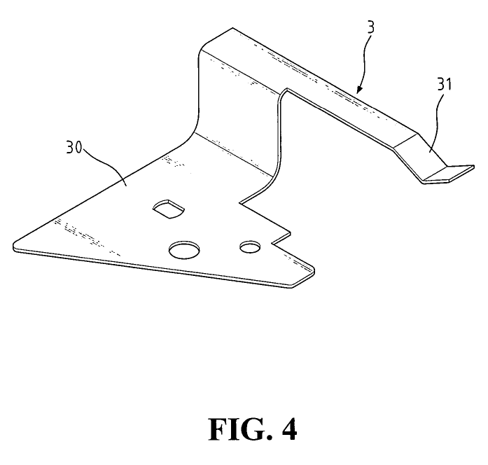

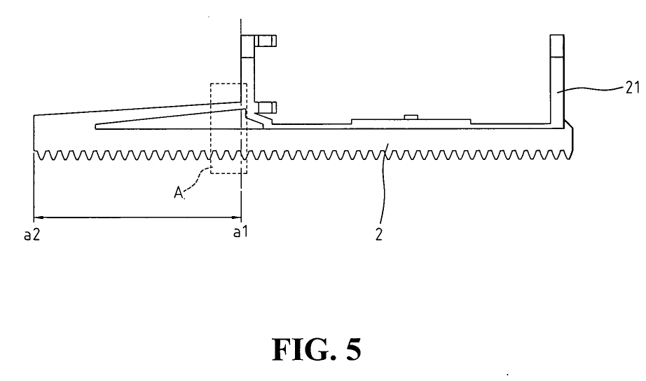

Elastic element 3 is preferably a metal flexible plate, as shown in FIG. 4, or plastic flexible plate or rubber body (not shown). The flexible plate shown in FIG. 4 includes an extensible flexible presser 31, and a base 30 attached to optical pickup head 1. When base 30 is attached to optical pickup head 1, flexible presser 3 1 presses against the top of rack 2; that is, elastic element 3 apply a force to the direction parallel to the center line of the teeth of rack 2. Rack 2 rotates around guide rod 5 in the rotation direction of gear 4. That is, rack 2 moves closer to the root of gear 4, until rack 2 touches rib 41. In the mechanism shown in FIG. 5, the structural strength of rack 2 decreases from a1 to a2. Therefore, the preferred embodiment of the present invention is to make flexible presser 31 presses against the intersection of the weak structure and strong structure, shown as the A segment near side plate 21 of FIG. 5. Therefore, the backlash between rack 2 and gear 4 can be reduced and the partial deformation of the end of rack 2 due to the weak structure can be improved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A device for reducing backlash of the transmission gear set of an optical pickup head, comprising an optical pickup head, a rack, an elastic element, a gear and a guide rod, guide rod penetrating the optical pickup head and rack, the guide rod being perpendicular to the center line of the teeth of rack, rack engaged to gear, gear driven by a motor so that optical pickup head and rack moving straight along guide rod, optical pickup head attached to an elastic element, elastic element apply a force to rack so that rack rotating around the guide rod and moving closer to the root of gear.

2. The device as claimed in claim 1, wherein gear comprises a rib closer to the root of gear for rack to touch in order to control the rotation amount of rack.

3. The device as claimed in claim 1, wherein elastic element is a metal flexible plate.

4. The device as claimed in claim 1, wherein elastic element is a rubber body.

5. The device as claimed in claim 1, wherein elastic element is a plastic flexible plate.

6. The device as claimed in claim 3, wherein metal flexible plate touches rack at the intersection of weak structure and strong structure.

7. The device as claimed in claim 4, wherein rubber body touches rack at the intersection of weak structure and strong structure.

8. The device as claimed in claim 5, wherein plastic flexible plate touches rack at the intersection of weak structure and strong structure.
